(19) United States
(12) Patent Application Publication
(10) Pub. No.: US 2009/0227164 A1
(43) Pub. Date: Sep. 10, 2009

(54) Superhydrophobic Coating of a Polymer Non-Woven, Especially a Polypropylene Nonwoven

(76) Inventors: Thomas Broch-Nielsen, Aalborg Ost (DK); Jens Bondergaard, Silkeborg (DK); Flemming Besenbacher, Arhus (DK); Peter Kingshott, Skanderborg (DK); Søren Mølgaard, Aalborg (DK)

Correspondence Address: DILWORTH & BARRESE, LLP, 1000 WOODBURY ROAD, SUITE 405, WOODBURY, NY, 11797, US

(21) Appl. No.: 12/084,090

(22) PCT Filed: Oct. 27, 2006
(86) PCT No.: PCT/EP2006/010375

§ 371 Date: Apr. 25, 2008

(30) Foreign Application Priority Data
Oct. 27, 2005 (DE) 102005051550.9

(51) Int. Cl. B32B 27/12; B05D 1/02; B05D 1/18; B05D 3/12; B29C 47/00; B05D 1/04; B05D 1/28

(52) U.S. Cl. 442/79; 427/427.4; 427/430.1; 427/240; 264/465; 427/458; 427/429

(57) ABSTRACT

A superhydrophobic coating of a nonwoven material is coated with a spongy mesh structure in the micro and nano ranges.

The present invention is directed to a polymer nonwoven, especially a polypropylene nonwoven.

A plane surface of pure polypropylene has a contact angle with water (wetting angle) of approximately 90-100°. This contact angle, which is in the grey zone between hydrophilicity and hydrophobicity, is reflected in the mediocre water repellent properties of nonwoven webs of polypropylene fibres. Generally two major types of hydrophobicity are distinguished, for textile materials. The first type is a measure for the water repellent/water repelling properties of a material, while the other is a measure of the resistance to permeability. The permeability-type of hydrophobicity is subdivided into two different types of permeability. Permeability for liquid water and permeability for water vapour resulting from the diffusion of water molecules. The degree of permeability for liquid water is a function of pore radius, wetting angle, degree of sublimation, and imperfections in the material. For polypropylene nonwovens, the two types of hydrophilicity are often not fully mutually independent. An increase in the water repellent properties is often tantamount to a decrease in permeability and vice versa.

Until now, the problem of the increase in the two types of hydrophobicity of polypropylene nonwovens has been solved in at least four different ways: (1) Coating with another material than polypropylene e.g. with a film for decreasing permeability, (2) using very thin fibres (e.g. melt-blown fibres) for decreasing the permeability of liquid water while simultaneously increasing the permeability for vapour and increasing the water repellent properties, (3) using fibres with special cross-sectional profiles (e.g. star-shaped) for increasing the water repellent properties, and finally (4) chemical modification of the surface of the fibres so that the free surface energy is reduced and thus the water repellent properties are increased.

Surfaces with high roughness are formed using methods (2) and (3) so that natural water repellent superhydrophobic surfaces are mimicked (e.g. the surfaces of certain leafs (e.g. those of the lotus plant, nelumbo nucifera) or insect wings).

A high degree of hydrophobicity (of the water repellent kind) is not expected from any of the present methods. Especially the chemical modifications to reduce the free surface energy have been shown to give water contact angles with maximum values of only 120°. These chemical modifications were achieved by chemical bonding of —CF₃ groups to a smooth surface [as reported in: S. R. Coulson et al., J. Phys. Chem. B 104, 8836 (2000); W. Chen et al., Langmuir 15, 3395 (1999); as well as in other sources].

It is the object of the present invention to increase the water repellent properties of nonwoven fabrics of a polymer, especially polypropylene.

This object is achieved by a superhydrophobic coating of a nonwoven, with the nonwoven material being coated with a spongy mesh structure with features in the micro and nano ranges as described in claim 1. The coating material according to the invention is non-fluorized polypropylene, a non-fluorized propylene copolymer, a non-fluorized polyethylene or a non fluorized polyethylene terephthalate.

Preferred embodiments of the invention are the subject matter of the dependent claims.

The polymer or copolymer can, for example, each have a linear, star-shaped, branched or dendritic structure.

The coating can comprise a hydrophobic degradable polymer having a self-cleaning surface due to erosion.

The coating can be obtainable in that a specific amount of the soluble coating material is dissolved in a solvent.

In accordance with a preferred embodiment, a precipitator can be added here to obtain precipitation of the coating material.

The superhydrophobic coating can now be obtained in that the solution is applied to the nonwoven by dip coating. Alternatively, the solution can also be sprayed onto the nonwoven. Finally, the solution can also be applied to the nonwoven by transfer coating. The solution can also be applied to the nonwoven using electrospray processes, electrospinning or spin coating.

The nonwoven material can advantageously comprise polypropylene.

Alternatively, the nonwoven material can comprise polyethylene, polyethylene terephthalate or combinations of polyethylene, polyethylene terephthalate or polypropylene.

The coating can be obtainable by dissolving an amount of the polypropylene in a solvent chosen from one of the following groups of solvents: o-xylene, p-xylene, stearic acid, paraffins, iso-paraffins, ortho-dichlorobenzene (ODCB) or trichlorobenzene (TCB).

In accordance with a preferred embodiment of the invention, the coating material can form a mesh-like structure as agglomerated material, said structure comprising spherules having a diameter of 0.1 to 15 μm. The spherules can be connected by cylindrical strands made of the same material and having a diameter of less than 1 μm. Finally, the spherules can also have a rough surface.

The agglomerated material is preferably fused with the nonwoven support matrix.

The added precipitator can be selected from a group comprising methylethylketone, isopropylalcohol or cyclohexane.

The nonwoven can be needled, water jet solidified, spunbonded, spunmelt, meltblown or airlaid. It can be produced from a combination of correspondingly made nonwoven layers, for example from a combination of layers of spunbond nonwoven and spunmelt nonwoven.

The substance weight of the coating can advantageously amount to between 0.5 gsm and 200 gsm.

A preferred method for the manufacture of a superhydrophobic coating of a nonwoven consists of adding the solvent, including the coating material dissolved in the solvent, to the nonwoven such that phase separation takes place between the nonwoven fibres, with the dissolved coating material agglomerating and the solvent evaporating during the phase separation.

The size of the agglomerates can be set by the change in the evaporation rate of the solvent. In this connection, a comparatively slow drying can be varied with a comparatively fast drying. A comparatively fast drying can take place by vacuum drying, air drying or heating. A comparatively slow drying, in contrast, can be achieved by drying in a moist atmosphere or by cooling.

In accordance with another preferred embodiment of the method, the coating material is added to the solvent at a ratio of 0.1 to 75 mg per ml of solvent, with the solvent optionally being heated on the addition of the coating material.

A further solution to the initially named object, for which protection is independently claimed, comprises a superhydrophobic coating of a nonwoven in which the nonwoven material is coated with a spongy mesh structure in the micro range or nano range, with the coating material being polypropylene, a polypropylene copolymer, a fluorized homopolymer, a fluorized grafted copolymer or a block polymer, diblock copolymer or a triblock copolymer or another multiblock copolymer, with all blocks or at least some blocks being fluorized.

Preferred methods for the manufacture of a coating in accordance with claim 22 result from one of the claims 23 to 30.

Accordingly, a method for the manufacture of a superhydrophobic coating of a nonwoven can comprise the coating material being dissolved in a solvent.

The coating material can advantageously be applied in the form of a particle suspension presented in a solvent, with the particles being either completely or partly soluble or being present in the chosen solvent in the form of a gel.

In this connection, the coating material present as a particle suspension in the solvent can lie in orders of magnitude from 1 nm to 100 μm.

The coating material can advantageously be presented in a solvent, with the coating material comprising particles which have an outer shell of polypropylene or fluoropolymer and whose core region has a reservoir of hydrophobic molecules which can diffuse at the outer side of the particles to form a self-arising hydrophobic layer on the outer surface of the particles.

In accordance with a further particular aspect of the invention, a precipitator can be added to the solvent and additionally, or in place thereof, a fluorized interface-active substance can be added thereto in which the surface-active substance is linear, star-shaped or dendritic in its structure and/or in which the surface-active substance is a modified fatty acid modified with fluorized groups.

The solvent can preferably be applied to the nonwoven by dip coating.

Alternatively, the solution can be applied to the nonwoven by spin coating. Alternatively, the solution can be applied to the nonwoven using an electrospray process.

The underlying solution of the invention is a coating with a spongy mesh structure having features in the micro and nano ranges. If polypropylene is used as the material, the coating is pure or almost pure polypropylene in its final form so that the hydrophobicity is only achieved through the structure of the material (no chemical modifications contribute to increasing the hydrophobicity). The coating can be fused to the fibres of the nonwoven so that the attachment of the mesh can be very strong.

The finished product is e.g. pure or almost pure polypropylene so that no toxic coatings or components are present. No toxic chemical treatment is needed to lower the free surface energy. The permeability for water is lowered. The permeability for air is decreased.

The specific properties of the coating are achieved through its micro and nanostructure. In order to produce the coating, an amount of polypropylene (typically, but not limited to, 10-40 mg/ml) is dissolved in o-xylene, p-xylene or possibly another suitable organic solvent such as stearic acid, paraffins or iso-paraffin (other less suitable solvents for polypropylene are ODCB (orto di-chlor benzene) or TCB (trichlorbenzene)) at a sufficiently high temperature (e.g. 130° C. for xylene). A precipitator such as methyl ethyl ketone, isopropyl alcohol or cyclohexane may be added to the solution. Coatings obtained from solutions with precipitators are reported to give higher contact angles than those obtained from solutions without precipitators. The precipitator is a non-solvent that acts as a phase separator.

The present invention renders nonwovens hydrophobic in the sense that it repels water and has very high water contact angles. It has previously been shown [H. Y. Erbil et al, Science 299, 1377-1379 (2003)], that coatings of this type applied to solid, planar surfaces produce water contact angles of up to above 150°, thus qualifying the coating as superhydrophobic (a superhydrophobic material is defined as a material on which water contact angles are above 150°).

After preparation of the solution, it is either applied to a nonwoven by dip coating at a temperature sufficiently low to not damage the nonwoven (approximately 80° C. for polypropylene) or is sprayed onto a nonwoven. The solution could also be applied to the nonwoven by transfer coating. To avoid the formation of superhydrophobic film on the transfer roller, the transfer roller could also be heated. As the solution cools down, nucleation centres for the crystallization of the polypropylene are formed which, on further cooling, develop into spherulites and cylindrical bridges between the spherulites so that a large porous network from which the solvent evaporates is created.

When the organic solvent evaporates from the coating, a spongy (referring to the shape) micro and nano structured porous mesh remains. Depending on the coating temperature and on the coating method, the polypropylene residues are either fused with the nonwoven fibres or not fused with the nonwoven fibres. “Fused” is to be understood such that the dried coating is melted onto (chemically bonded to) the fibres in the substrate material without the use of a bonding material different from polypropylene.

In many cases, it is of course an advantage, that the coating adheres well to the substrate. Depending on the coating-method, the material applied is either present on the surface only (is e.g. achieved by spraying) or it fills up the cavities of the nonwoven over the whole thickness of the nonwoven (is e.g. achieved by dip coating). The structure of the mesh (e.g. the number-ratio of bridges relative to spherulites or the surface morphology of the spherulites) is likewise a controllable result of the coating method.

The coating can be combined with other methods of increasing the hydrophobicity. Especially treatments that render the nonwoven less permeable could be complementary to the water repelling coating proposed in this patent.

The products to be coated could be fibres (staple fibres, spunbond fibres, meltblown fibres or other fibres), or they could be nonwovens produced from said fibres.

The fibres could be bicomponent fibres, of the form sheath core, side by side, segmented pie, island in the sea and others. The combination can be polypropylene with other polymers, such as other polyolefins or PET, PA, PU etc.

The nonwoven could be of the type needlefelt, hydroentangled, spunbond, spunmelt or a nonwoven of the type S, SS, SSS, SMMS, SSMMS, SMMMS, SSMMMS etc. with a variety of bonding methods, e.g. calendering, IR bonding, through air bonding, needling, chemical bond, hydro entanglement, and others. This of course gives rise to a large number of possible combinations, but this does not affect the effect of the coating directly, although the difference in structure of the products, can possess different inherent hydrophobicities.

The coating described in this patent can also be applied to other polymers so that it could be used in the exact same way on PE, PET and other polymers, and all the above statements therefore also apply to them.

1. A superhydrophobic coating of a nonwoven, wherein the nonwoven material is coated with a spongy mesh structure in the micro and nano ranges, with the coating material being non-fluorized polypropylene, a non-fluorized propylene copolymer, a non-fluorized polyethylene or a non fluorized polyethylene terephthalate.

2. A superhydrophobic coating of a nonwoven according to claim 1, wherein the polymer or copolymer in each case has a linear, star-shaped, branched or dendritic structure.

3. A superhydrophobic coating of a nonwoven according to claim claims 1, wherein the coating comprises a hydrophobic degradable polymer having a self-cleaning surface due to erosion.

4. A superhydrophobic coating of a nonwoven according to claim 1, wherein the coating is obtainable by dissolving a specific amount of the dissolving material in a solvent.

5. A superhydrophobic coating of a nonwoven according to claim 4 wherein a precipitator is added.

6. A superhydrophobic coating of a nonwoven according to claim 4, wherein the solution is dip coated on the nonwoven.

7. A superhydrophobic coating of a nonwoven according to claim 4, wherein the solution is sprayed onto the nonwoven.

8. A superhydrophobic coating of a nonwoven according to claim 4, wherein the solution is applied to the nonwoven by transfer coating.

9. A superhydrophobic coating of a nonwoven according to claim 4, wherein the solution is applied to the nonwoven using electrospray, electrospinning or spin coating.

10. A superhydrophobic coating of a nonwoven according to claim 1, wherein the nonwoven material is polypropylene.

11. A superhydrophobic coating of a nonwoven according to claim 1, wherein the nonwoven material is polyethylene (PE), polyethyleneterephthalate (PET) or combinations of polyethylene (PE), polyethyleneterephthalate (PET) or polypropylene.

12. A superhydrophobic coating of a nonwoven according to claim 1, wherein the coating is obtainable by dissolving an amount of the polypropylene in a solvent which is chosen from the following group of solvents: o-xylene, p-xylene, stearic acid, paraffins, iso-paraffins, orto di-chlor benzene (ODCB), or trichlor-benzene (TCB).

13. A superhydrophobic coating of a nonwoven according to claim 12, wherein agglomerated material has a mesh structure which comprises spherules having a diameter from 0.1 to 15 μm.

14. A superhydrophobic coating of a nonwoven according to claim 13, wherein the spherules are connected by cylindrical strands of the material having a diameter of less than 1 μm.

15. A superhydrophobic coating of a nonwoven according to claim 13, wherein the spherules have a rough surface.

16. A superhydrophobic coating of a nonwoven according to claim 12, wherein the agglomerated material is fused with the nonwoven support matrix.

17. A superhydrophobic coating of a nonwoven according to claim 1, wherein the added precipitator is chosen from a group consisting of: methyl ethyl ketone, isopropyl alcohol or cyclohexane.

18. A superhydrophobic coating of a nonwoven according to claim 1, wherein the nonwoven is needled, water jet solidified, spunbonded, spunmelt, meltblown or airlaid or comprises a combination of correspondingly manufactured nonwoven layers.

19. A superhydrophobic coating of a nonwoven according to claim 1, wherein the weight of the coating amounts to between 0.5 gsm and 200 gsm.

20. A method of manufacturing a superhydrophobic coating of a nonwoven according to claim 1, wherein solvent, including the coating material dissolved in the solvent, is added t the nonwoven so that phase separation takes place between the nonwoven fibers, with the dissolved coating material agglomerating and the solvent evaporating during the phase separation.

21. A method of manufacturing a superhydrophobic coating of a nonwoven according to claim 12, wherein the coating material to be dissolved being added to the solvent at a ratio of 0.1 to 75 mg per ml of solvent, with the solvent selectively being heated on the addition of the coating material.

22. A superhydrophobic coating of a nonwoven, wherein the nonwoven material is coated with a spongy mesh structure in the micro or nano ranges, with the coating material being polypropylene, a polypropylene copolymer, a fluorized homopolymer, a fluorized grafted copolymer or a block polymer, a diblock copolymer or a triblock copolymer or another multiblock copolymer, with all blocks or at least some blocks being fluorized.

23. A method of manufacturing a superhydrophobic coating of a nonwoven according to claim 22, wherein the coating material is dissolved in a solvent.

24. A method of manufacturing a superhydrophobic coating of a nonwoven according to claim 22, wherein the coating material is applied in the form of a particle suspension presented in a solvent, with the particles being either completely or partly soluble in the chosen solvent or being present in the chosen solvent in the form of a gel.

25. A method according to claim 24, wherein the particle size of the coating materials present in the solvent as a particle suspension lies in an order of magnitude from 1 nm to 100 μm.

26. A method of manufacturing a superhydrophobic coating of a nonwoven according to claim 22, wherein the coating material is presented in a solvent, with the coating material comprising particles which have an outer shell of polypropylene or fluoropolymer and whose core region has a reservoir of hydrophobic molecules which can diffuse to the outer side of the particles to form a self-generated hydrophobic layer on the outer surface of the particles.

27. A method of manufacturing a superhydrophobic coating of a nonwoven according to claim 22, wherein a precipitator is added to the solvent; and/or wherein a fluorized interface active substance is added thereto in which the surface active substance is linear, star-shaped or dendritic in its structure; and/or wherein the surface active substance is a modified fatty acid modified with fluorized groups.

28. A method of manufacturing a superhydrophobic coating of a nonwoven according to claim 22, wherein the solution is applied to the nonwoven by dip coating.

29. A method of manufacturing a superhydrophobic coating of a nonwoven according to claim 22, wherein the solution is applied to the nonwoven by spin coating.

30. A method of manufacturing a superhydrophobic coating of a nonwoven according to claim 22, wherein the solution is applied to the nonwoven using an electrospray method.
